(19) United States
(12) Patent Application Publication
(10) Pub. No.: US 2016/0042861 A1
(43) Pub. Date: Feb. 11, 2016

(54) PRINTED WIRING BOARD

(71) Applicant: IBIDEN CO., LTD., Ogaki-shi (JP)

(72) Inventors: Yasuhiko MANO, Ogaki-shi (JP); Toshihiko ONOGI, Ogaki-shi (JP); Kazuhiro YOSHIKAWA, Ogaki-shi (JP); Yuki TANAKA, Ogaki-shi (JP); Haruhiko MORITA, Ogaki-shi (JP); Takashi KARIYA, Ogaki-shi (JP)

(73) Assignee: IBIDEN CO., LTD., Ogaki-shi (JP)

(21) Appl. No.: 14/820,666

(22) Filed: Aug. 7, 2015

(30) Foreign Application Priority Data
Aug. 7, 2014 (JP) 2014-161662

(51) Int. Cl. H01F 27/28; H01F 27/245

(52) U.S. Cl. CPC H01F 27/2804; H01F 27/245; H01F 2027/2809

(57) ABSTRACT

A printed wiring board includes a core substrate having a cavity, an inductor component positioned in the cavity of the substrate, a first buildup layer formed on first surface of the substrate, and a second buildup layer formed on second surface of the substrate. The inductor component includes an insulating layer having first openings and a second opening formed between the first openings, conductive through holes formed in the first openings, respectively, a magnetic body formed in the second opening, a first interconnect formed on first surface of the insulating layer and connecting the conductive through holes on the first surface of the insulating layer, and a second interconnect formed on second surface of the insulating layer and connecting the conductive through holes on the second surface of the insulating layer, and the first interconnect, second interconnect and conductive through holes are positioned to form a spiral structure.

### CROSS-REFERENCE TO RELATED APPLICATIONS

The present application is based upon and claims the benefit of priority to Japanese Patent Application No. 2014-161662, filed Aug. 7, 2014, the entire contents of which are incorporated herein by reference.

### BACKGROUND OF THE INVENTION

1. Field of the Invention

The present invention relates to a printed wiring board provided with an inductor component, and a printed wiring board with a built-in inductor.

2. Description of Background Art

Japanese Unexamined Patent Application Publication No. 2008-270532 describes pressing an inductor part from a thick metal sheet (e.g., 100 to 300 μm) to reduce the resistance of the inductor. A substrate is bonded to the inductor. A buildup layer is subsequently formed on the substrate and the inductor part. The entire contents of this publication are incorporated herein by reference.

### SUMMARY OF THE INVENTION

According to one aspect of the present invention, a printed wiring board includes a core substrate having a cavity, an inductor component positioned in the cavity of the core substrate, a first buildup layer formed on a first surface of the core substrate, and a second buildup layer formed on a second surface of the core substrate on the opposite side of the substrate with respect to the first surface. The inductor component includes a resin insulating layer having multiple first openings and a second opening formed between the first openings, multiple conductive through holes including conductive material and formed in the first openings, respectively, a magnetic body including magnetic material and formed in the second opening, a first interconnect formed on a first surface of the resin insulating layer and connecting the conductive through holes on the first surface of the resin insulating layer, and a second interconnect formed on a second surface of the resin insulating layer and connecting the conductive through holes on the second surface of the resin insulating layer, and the first interconnect, the second interconnect and the conductive through holes are positioned to form a spiral structure.

According to another aspect of the present invention, a printed wiring board includes a core substrate, a first buildup layer formed on a first surface of the core substrate, and a second buildup layer formed on a second surface of the core substrate on the opposite side of the substrate with respect to the first surface. The core substrate has an inductor portion including multiple conductive through holes which includes conductive material and which is formed in multiple first openings in the core substrate, respectively, a magnetic body including magnetic material and formed in a second opening formed between the first openings, a first interconnect formed on a first surface of the core substrate and connecting the conductive through holes on the first surface of the core substrate, and a second interconnect formed on a second surface of the core substrate and connecting the conductive through holes on the second surface of the core substrate, and the first interconnect, the second interconnect and the conductive through holes are positioned to form a spiral structure.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a cross-sectional view of a printed wiring board with a built-in inductor component according to a first embodiment;

FIG. 2A through 2E are process diagrams illustrating a method of manufacturing a printed wiring board according to the first embodiment;

FIG. 3A through 3E are process diagrams illustrating a method of manufacturing a printed wiring board according to the first embodiment;

FIG. 4A through 4D are process diagrams illustrating a method of manufacturing a printed wiring board according to the first embodiment;

FIGS. 5A and 5B are process diagrams illustrating a method of manufacturing a printed wiring board according to the first embodiment;

FIGS. 6A and 6B are cross-sectional views of an inductor component according to the first embodiment of the invention;

FIGS. 7A and 7C are plan views illustrating a structural inductor element according to the first embodiment, FIG. 7B is a side view, and FIG. 7D is an exploded view illustrating the recesses inside an opening;

FIG. 8A through 8D are process diagrams illustrating a method of manufacturing an inductor component according to the first embodiment;

FIG. 9A through 9D are process diagrams illustrating a method of manufacturing an inductor component according to the first embodiment;

FIG. 10A through 10C are process diagrams illustrating a method of manufacturing an inductor component according to the first embodiment;

FIG. 11 is a cross-sectional view of a printed wiring board with a built-in inductor component according to a second embodiment;

FIG. 12A through 12D are process diagrams illustrating a method of manufacturing a core substrate according to the second embodiment;

FIG. 13A through 13D are process diagrams illustrating a method of manufacturing a core substrate according to the second embodiment; and

FIG. 14A through 14C are process diagrams illustrating a method of manufacturing a core substrate according to the second embodiment.

### DETAILED DESCRIPTION OF THE EMBODIMENTS

The embodiments will now be described with reference to the accompanying drawings, wherein like reference numerals designate corresponding or identical elements throughout the various drawings.

### Embodiment 1

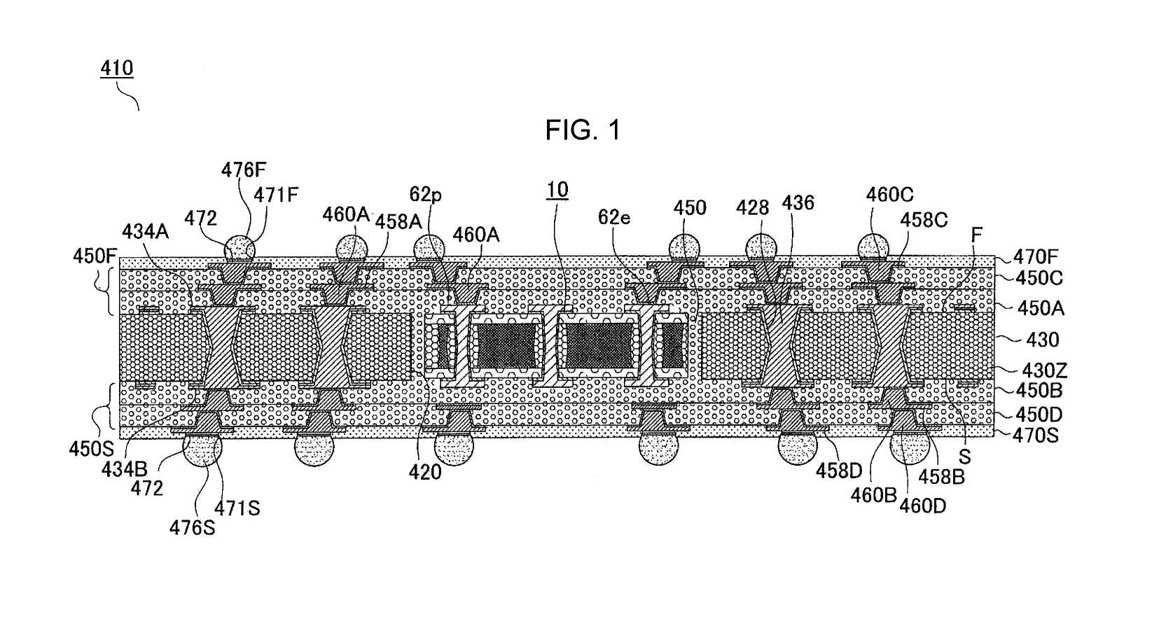

FIG. 1 is a cross-sectional view of a printed wiring board 410 with a built-in inductor component 10 according to a first embodiment. The printed wiring board 410 includes a core substrate 430. The core substrate 430 is formed from an insulating base material (430Z) having a first surface (F), and a second surface (S) opposite the first surface (F), with a first conductive layer (434A) and a second conductive layer (434B) on the first surface (F) and the second surface (S) of the insulating base material (430Z) respectively, and a conductive through hole 436 connecting the first conductive layer (434A), and the second conductive layer (434B). The core substrate includes a first surface (F), and a second surface (S) opposite the first surface (F). The first surface of the core substrate 430 and the first surface of the insulating base material (430Z) are the same surface; the second surface of the core substrate and the second surface of the insulating base material are the same surface. The conductive through hole 436 is formed by filling a through hole 428 formed in the insulating base material (430Z) with metal plating.

An opening 420 is formed in the core substrate 430 and the inductor component 10 is housed inside the opening. A filled resin 450 fills between the sidewalls of the opening 420 and the sidewalls of inductor component 10. The sidewalls of the inductor component 10 are constituted by a resin core base material 20, a first resin insulating layer (50F), and a second resin insulating layer (50S). The core substrate 430 is created by soaking a core of fiberglass cloth in resin. The resin is exposed from the sidewalls of the opening 420 in the core substrate 430. Consequently, the sidewalls of the inductive component and the sidewalls of the opening 420 are each close to the filled resin. The filled resin 450 may contain magnetic particles. Thus, the Q value or the inductance value of the inductor tends not to decrease. For example, the magnetic particles may be iron III oxide, cobalt iron oxide, iron, ferrosilicon, magnetic metal alloy, or ferrite, or the like.

The printed wiring board 410 may further include an upper buildup layer (450F) on the first surface (F) of the core substrate 430. The upper buildup layer (450F) includes an insulating layer (upper insulating resin interlayer, 450A) formed on the first surface (F) of the core substrate 430, a conductive layer (upper conductive layer, 458A) formed on the insulating layer (450A), a conductive via (upper conductive via, 460A) passing through the insulating layer (450A) and connecting a first conductive layer (434A), a conductive through hole 436, and electrodes (62p, 62e) on the inductor component 10 with the conductive layer (458A). The upper buildup layer (450F) further includes an insulating layer (uppermost insulating resin interlayer, 450C) on the insulating layer (450A) and the conductive layer (458A), and a conductive via (uppermost conductive via, 460C) passing through the conductive layer (uppermost conductive layer, 458C) on the insulating layer (450C) and the insulating layer (450C) and connecting the conductive layer (458A) and the conductive via (460A) with the conductive layer (458C).

The printed wiring board 410 may further include a lower buildup layer (450S) on the second surface (S) of the core substrate 430. The lower buildup layer (450S) includes an insulating layer (lower insulating resin interlayer, 450B) formed on the second surface (S) of the core substrate 430, a conductive layer (lower conductive layer, 458B) formed on the insulating layer (450B), a conductive via (lower conductive via, 460B) passing through the insulating layer (450B) and connecting a second conductive layer (434B) and a conductive through hole 436 with the conductive layer (458B). The lower buildup layer (450S) further includes an insulating layer (lowermost insulating resin interlayer, 450D) on the insulating layer (450B) and the conductive layer (458B), and a conductive via (lowermost conductive via, 460D) passing through the conductive layer (lowermost conductive layer, 458D) on the insulating layer (450D) and connecting the conductive layer (458B) and the conductive via (460B) with the conductive layer (458D). The printed wiring board of the first embodiment may further include a solder resist layer (470F) containing an opening (471F) in the upper buildup layer (450F), and a solder resist layer (470S) containing an opening (471S) in the lower buildup layer (450S).

The conductive layers (458C, 458D), and the upper surfaces of conductive vias (460C, 460D) exposed from the openings (471F, 471S) in the solder resist layers (470F, 470S) function as pads. A thin metal film (protective film, 472) may be formed on the pads and composed of Ni/Au, Ni/Pd/Au, Pd/Au, or OSP. Solder bumps (476F, 476S) are formed on the protective film. An IC chip (not shown) may be mounted on the printed wiring board 410 via the solder bumps 476F formed on the upper buildup layer (450F). The printed wiring board 410 may be mounted to a motherboard via the solder bumps (476S) formed on the lower buildup layer (450S).

The inductor component 10 is embedded in the opening (cavity, 420) formed in the core substrate 430; therefore, the printed wiring board according to the first embodiment may have a high-value inductor built in. Given that there are an equal number of conductive layers on the upper (first) buildup layer (450F) and the lower (second) buildup layer (450S), the core substrate has a symmetrical structure, reducing the likelihood of warping and increasing the reliability thereof.

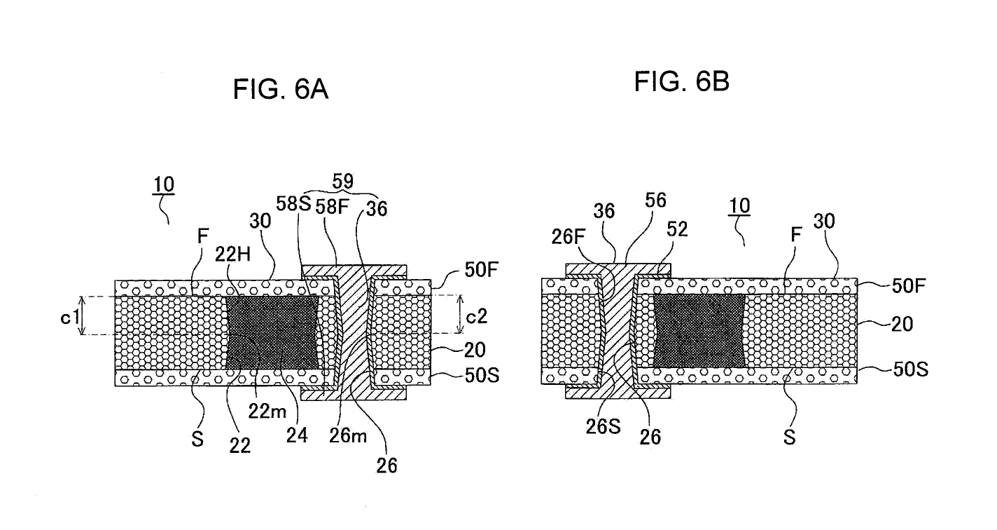

FIGS. 6A and 6B are cross-sectional views of an inductor component 10 according to the first embodiment. The inductor component 10 is provided with a resin core base material 20 which includes an opening (second opening, 22) and a magnetic body 24 containing magnetic material inside the opening; a first resin insulating layer (50F) formed on the first surface (F) of the core base material; a second resin insulating layer (50S) formed on the second surface (S) of the core base material; a first conductive pattern (58F) formed on the first resin insulating layer (50F); a second conductive pattern (58S) formed on the second resin insulating layer (50S); and a conductive through hole 36 connecting the first conductive pattern (58F) and the second conductive pattern (58S). The core base material may be from 0.1 mm to 0.5 mm thick.

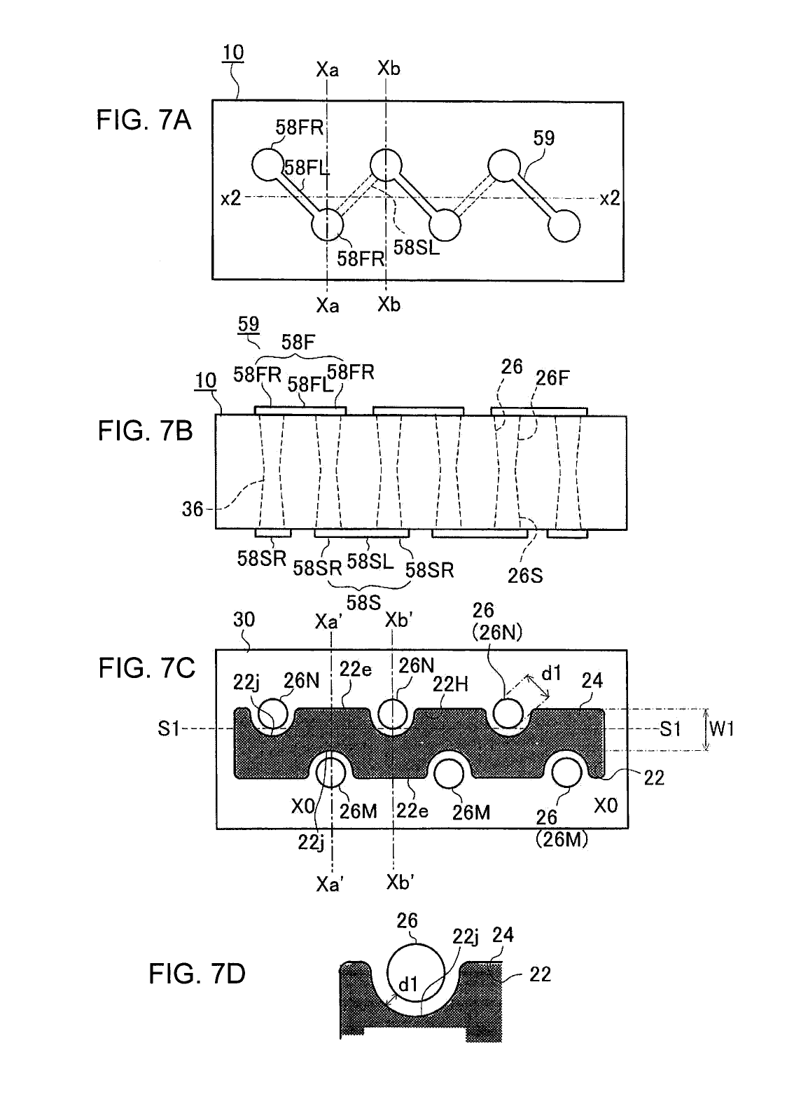

FIG. 7A is a plan view illustrating the inductor component 10; and FIG. 7B is the side view. The first conductive pattern (58F) on the first surface is composed of through hole lands (58FR) formed directly on the conductive through hole 36, and a connection pattern (58FL) connecting a through hole land (58FR) and a through hole land (58FR). The second conductive pattern (58S) on the second surface is composed of through hole lands (58SR) formed directly on the conductive through hole 36, and a connection pattern (58SL) connecting a through hole land (58SR) and a through hole land (58SR). The first conductive pattern (58F) and the second conductive pattern (58S) are positioned in a spiral through the conductive through hole 36 (i.e., formed in a spiral shape along an axial line in a direction parallel to the front and rear surfaces of the inductor component). The first conductive pattern (58F), second conductive pattern (58S), and the conductive through hole 36 thereby form an inductor 59.

FIG. 6A corresponds to the cross section Xa-Xa through FIG. 7A, and FIG. 6B corresponds to the cross section Xb-Xb through FIG. 7A. As illustrated in the diagrams, the resin insulating layer (50F) is formed on the first surface (F) of the core base material 20, and the first conductive pattern (58F) is formed on said resin insulating layer (50F) in the inductor component 10. The resin insulating layer (50S) is formed on the second surface (S) of the core base material 20, and the second conductive pattern (58S) is formed on said resin insulating layer (50S). The conductive through hole 36 which connects the first conductive pattern (58F) and the second conductive pattern (58S) is formed inside a through hole (first opening, 26) formed in the core base material 20. The conductive through hole 36 is formed by fill plating inside the through hole 26. The through hole 26 is constituted by a first opening portion (26F) which is a truncated cone (cylinder) tapering with decreasing diameter from the first surface (F) toward the second surface (S), and second opening portion (26S) which is a truncated cone tapering with decreasing diameter from the second surface toward the first surface. The sidewalls of the opening 22 housing the magnetic body 24 also incline toward the center in the same manner as the through hole 26. That is, the cross section of the opening 22 is a horizontal V, where width from the first surface (F) toward the second surface (S) narrows as the width from the second surface (S) toward the first surface (F) also narrows. The site (22m) of the narrowest portion of the opening 22 is at the center position of a laminate 30, and the site (26m) of the smallest diameter of the through hole 26 is also at the center position of the laminate 30. The distance (c1) from the first surface (F) to the site (22m) in the opening 22 is substantially equal to the distance (c2) from the first surface (F) to the site (26m) in the through hole 26.

FIG. 7C is a plan view illustrating the through holes 26 constituting the conductive through holes 36 in the inductor component 10 illustrated in FIG. 7A, and the formation of the opening 22 which houses the magnetic body 24. FIG. 6A corresponds to the cross section Xa′-Xa′ through FIG. 7C, and FIG. 6B corresponds to the cross section Xb′-Xb′ through FIG. 7C. The through holes 26 are formed in two rows, a first row of through holes (26N), and a second row of through holes (26M). The conductive through holes in the first row of through holes (26N), illustrated in FIG. 7A and the conductive through holes in the second row of through holes (26M) are respectively connected to each other. The opening 22 which houses the magnetic body 24 is disposed between the first row of through holes (26N) and the second row of through holes (26M). Recesses (22j) and projections (22e) are formed in the sidewalls (22H) of the opening 22. The recesses (22j) are provided at positions corresponding to the through holes (conductive through holes), and the projections (22e) are provided corresponding to the locations between a through hole (conductive through hole) and the next through hole (conductive through hole). The projections (22e) protrude from a line S1-S1 connecting the sidewalls of a row of through holes toward the through holes. As illustrated in FIG. 7D, the recesses (22j) are formed so that a distance (d1) therefrom to the periphery of the through hole 26 is uniform.

The projections and recesses are formed in the sidewalls (22H) of the opening 22 housing the magnetic body in the inductive part according to the embodiment. A recess (22j) is provided corresponding to the location of an individual conductive through hole 36. A projection (22e) is provided corresponding to the location between a conductive through hole and the next conductive through hole in a row. The recesses (22j) and projections (22e) reduce the distance between the magnetic body 24 and the conductive through holes 36, thereby increasing the inductance value.

In the inductor component 10 according to the first embodiment, the first conductive pattern (58F) and the second conductive pattern (58S) on the front and rear of the core base material 20 are positioned in a spiral (spiral shape) through the conductive through holes 36 in the core base material, to form the inductor. A magnetic flux concentrates in the space surrounding the spirally formed first conductive pattern (58F) and second conductive pattern (58S). A magnetic material (magnetic body 24) is present at the concentration of the magnetic flux, increasing the density of the magnetic flux and allowing the desired inductance property (inductance value, Q value) to be obtained.

As illustrated in FIG. 7A, in the first embodiment, the inductor 59 in the inductor component 10 is a spiral looping about an axial line in a direction parallel to the plane of the core substrate 430 in the printed wiring board. Given that the inductor 59 loops horizontally and not in the thickness direction of the printed wiring board, the number of turns therein may be increased without increasing the thickness of the printed wiring board and allowing the desired inductance properties (inductance value, Q value) to be obtained. Because the magnetic flux in the inductor component 10 is generated along the axial line in a direction parallel to the plane of the core substrate 430 in the printed wiring board 410 illustrated in FIG. 1, a larger distance may be secured between said magnetic flux and the conductive through hole 436 which interferes therewith, ensuring that a strong magnetic flux can be generated. In other words, when the wiring for the inductor component is looped, the magnetic flux is generated perpendicular to the plane of the core substrate 430, thus reducing the distance between the wiring for the inductor component and the conductive layer (458A); this conductive layer (458A) interferes with and reduces the magnetic flux. The wiring for the inductor component and the conductive through hole 436 are separated by hundreds of micrometers in the printed wiring board according to the first embodiment. The wiring in the inductor component and the conductive layer (458A) are separated by only the thickness of the insulating resin interlayer (450A) which is tens of micrometers.

The inductor component according to the first embodiment is provided with conductive patterns (58F, 58S) on the resin insulating layers (50F, 50S) on the core base material 20. In this case the conductive patterns are provided on the resin insulating layers. Consequently this facilitates placing the conductive patterns closer together compared to when the conductive patterns and the magnetic body are connected.

In the inductor component according to the first embodiment, the magnetic body 24 and the conductive through hole 36 are formed in the opening 22 and the through hole 26 created in the core base material. Consequently, contact between the magnetic body 24 and the conductive through hole 36 can be avoided. As a result, this facilitates placing the conductive through holes closer together.

Manufacturing an Inductor Component According to the First Embodiment

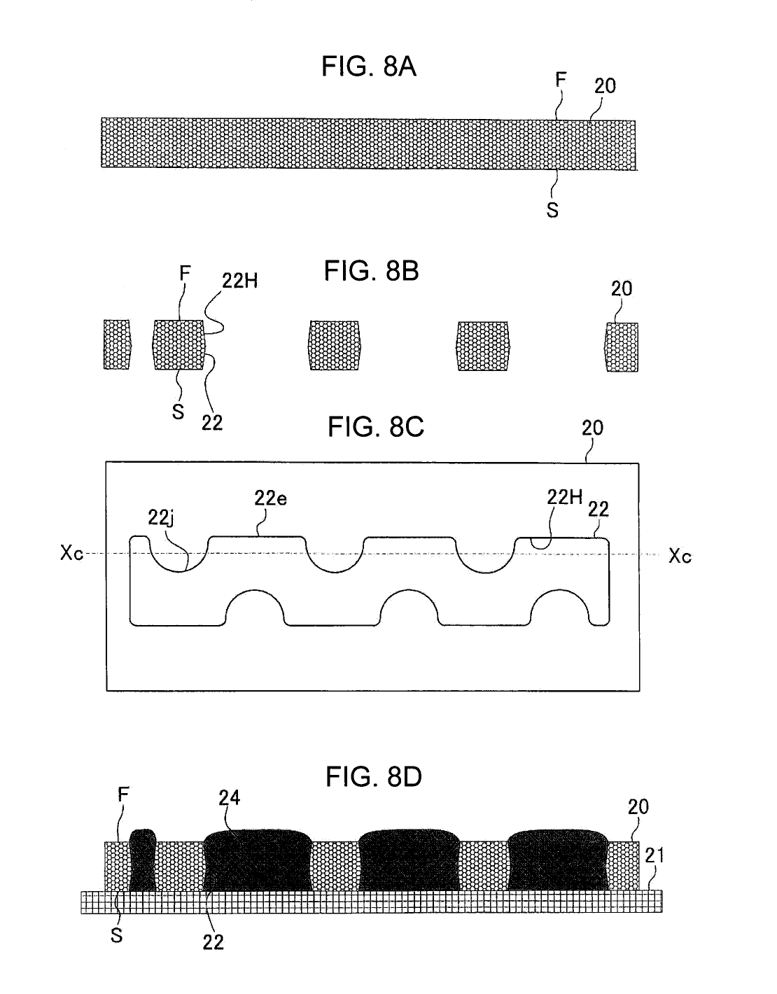

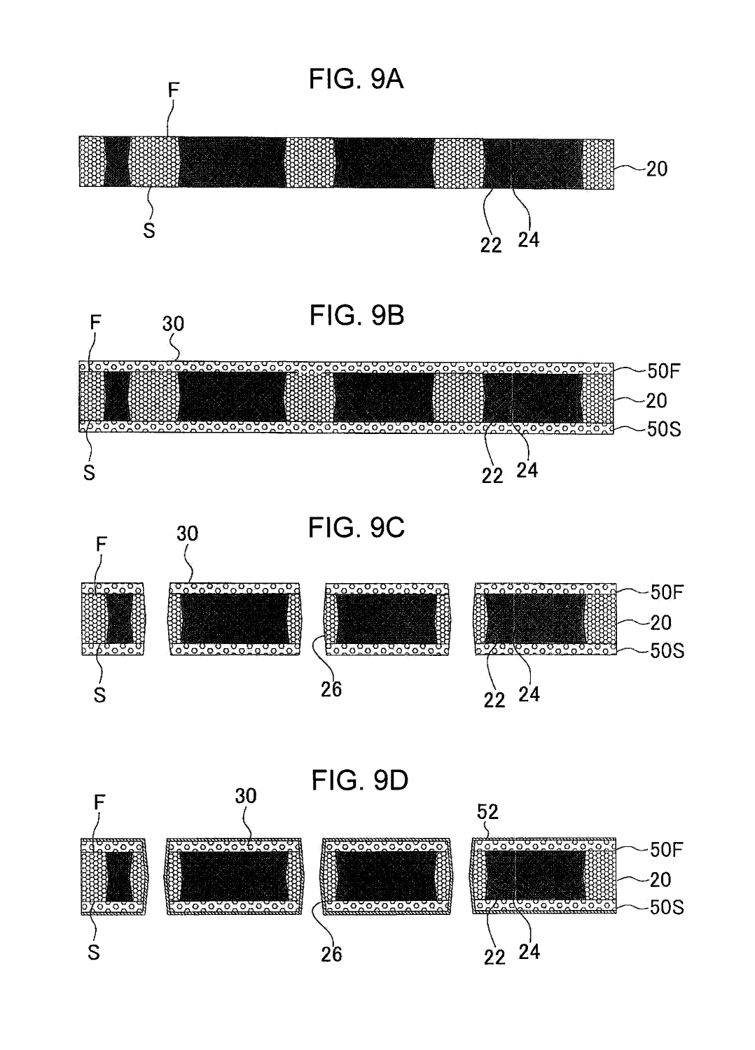

FIG. 8A through 10C illustrate a method of manufacturing an inductor component according to the first embodiment. A core base material 20 of thickness 0.15 mm is prepared (FIG. 8A). A core substrate is created by laminating a prepreg formed by soaking a core of fiberglass cloth in resin. The opening 22 is formed in the core base material 20 through laser machining (FIG. 8B). FIG. 8C is a plan view of the core base material. FIG. 8B is the cross-section Xc-Xc in FIG. 8C. Referring to FIG. 7C, and as above described, the recesses (22j) and projections (22e) are formed in the sidewalls (22H) of the opening 22. The sidewalls (22H) of the opening 22 incline toward the center similarly to the through hole because the sidewalls (22H) are formed from both surfaces with the same laser machining process used to create the through hole (later described). Moreover, given that the laser machining process creates the groove forming the opening 22, the minimum width (W1) depicted in FIG. 7C is greater than or equal to the maximum diameter (hl) of the through hole 26. The core base material 20 is mounted on a jig 21, and the magnetic body 24 is vacuum printed inside the opening 22 using a metal mask (FIG. 8D). The magnetic body is a composite of a magnetic metal and an organic material such as resin and the like. To obtain the desired inductance properties (inductance value, Q value) the magnetic body preferably has a magnetic permeability of 2 to 20, and a magnetic saturation of 0.1 T to 2 T. The surfaces of the core base material 20 are polished to reduce the unevenness on the base material surface to ±10 μm (FIG. 9A).

A prepreg of 40 μm is laminated onto the first surface (F) and the second surface (S) of the core base material 20 to form the first resin insulating layer (50F) and the second resin insulating layer (50S) and produce the laminate 30 (FIG. 9B). The laser used to create the opening 22 is used to create the through holes 26 at through hole formation sites in the laminate 30 (FIG. 9C). FIG. 7C depicts the formation sites for the through holes 26 in relation to the opening 22.

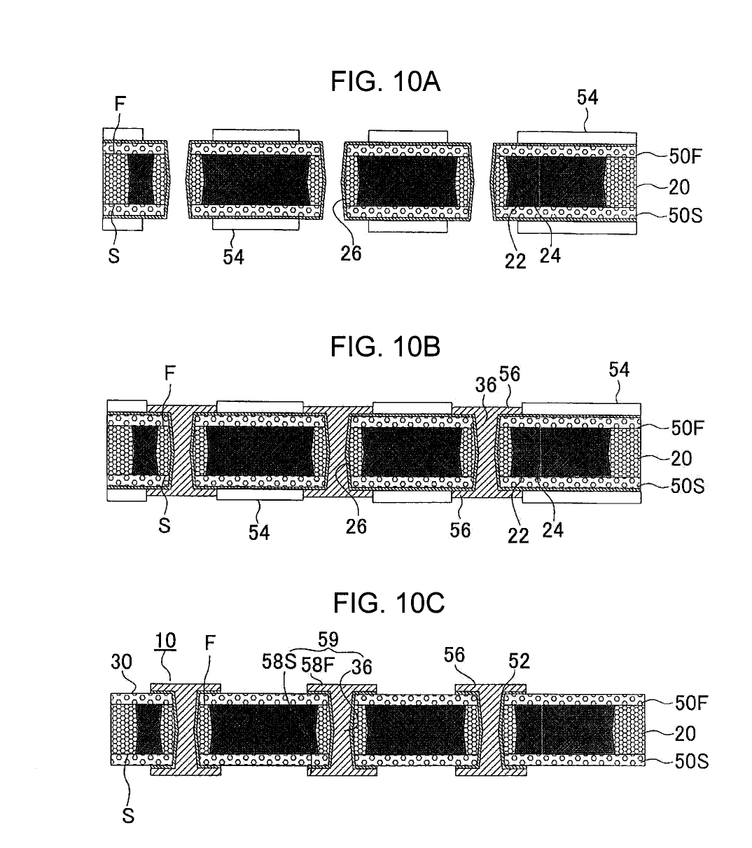

An electroless plating film 52 is formed on the first resin insulating layer (50F), the second resin insulating layer (50S), and the inner walls of the through holes 26 (FIG. 9D). A plating resist 54 is formed on the electroless plating film 52 (FIG. 10A). An electroplated film 56 is formed on the electroless plating film 52 on the portions of the electroless plating film 52 not protected by the plating resist 54. The inside of the through holes 26 are filled with electroplated film to form the conductive through holes 36 (FIG. 10B). The plating resist is peeled off to expose the electroless plating film on the portions not containing the electroplated film 56 to form the first conductive patterns (58F) and the second conductive patterns (58S) (FIG. 10C). Production of the inductor component is thereby complete (FIG. 6). The inductor component according to the first embodiment may be produced using the same methods for manufacturing the printed wiring board, thereby simplifying the production thereof.

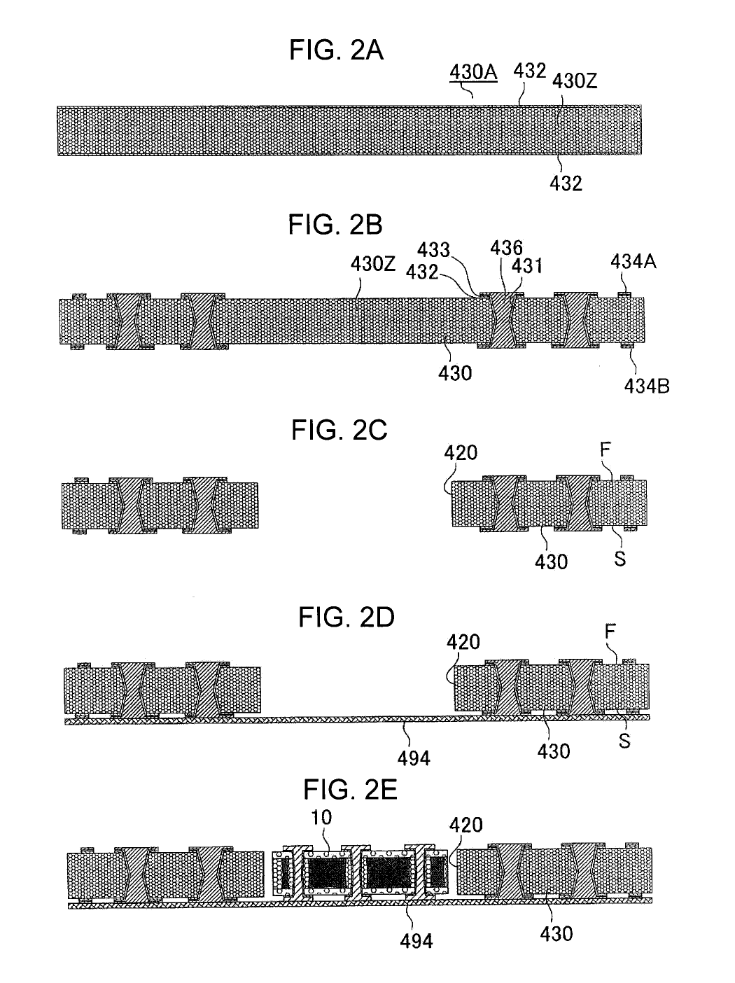

FIG. 2A through 5B illustrate a method of manufacturing a printed wiring board 410 according to the first embodiment. (1) A copper foil 432 is laminated on both surfaces of the insulating base material (430Z) creating a dual-surface copper-clad laminated sheet (430A) used as a start material (FIG. 2A). The insulating base material is 100 to 400 μm thick. The substrate is too weak when the insulating base material is less than 100 μm thick. Additionally the printed wiring board becomes too thick when the insulating base material exceeds 400 μm. The insulating base material includes the first surface (F) and the second surface (S) opposite the first surface. The surfaces (not shown) of the copper foil 432 are subject to blackening.

(2) The core substrate 430 is completed after machining the dual-surface copper-clad laminated sheet, and providing conductive through hole 436 through the upper conductive layer (434F) and the lower conductive layer (434S) and the through hole 431 (FIG. 2B). The upper and lower conductive layers (434F, 434S) are composed of the copper foil 432 and electroless plating film 423, and the electroplated film 426. The first surface of the core substrate 430 and the first surface of the insulating base material (430Z) are the same surface; the second surface of the core substrate 430 and the second surface of the insulating base material (430Z) are the same surface. The core substrate 430 may be produced using, for instance, the methods described in U.S. Pat. No. 7,786,390. The entire contents of this publication are incorporated herein by reference.

(3) A laser is used to form an opening 420 at the center portion of the core substrate 430 for housing the inductor component (FIG. 2C).

(4) A tape 494 is adhered to the second surface (S) of the core substrate 430. The tape covers the opening 430 (FIG. 2D). The tape 494 may be a PET film, for example.

(5) The inductor component 10 is placed on the portion of the tape 494 exposed through the opening 420 (FIG. 2E).

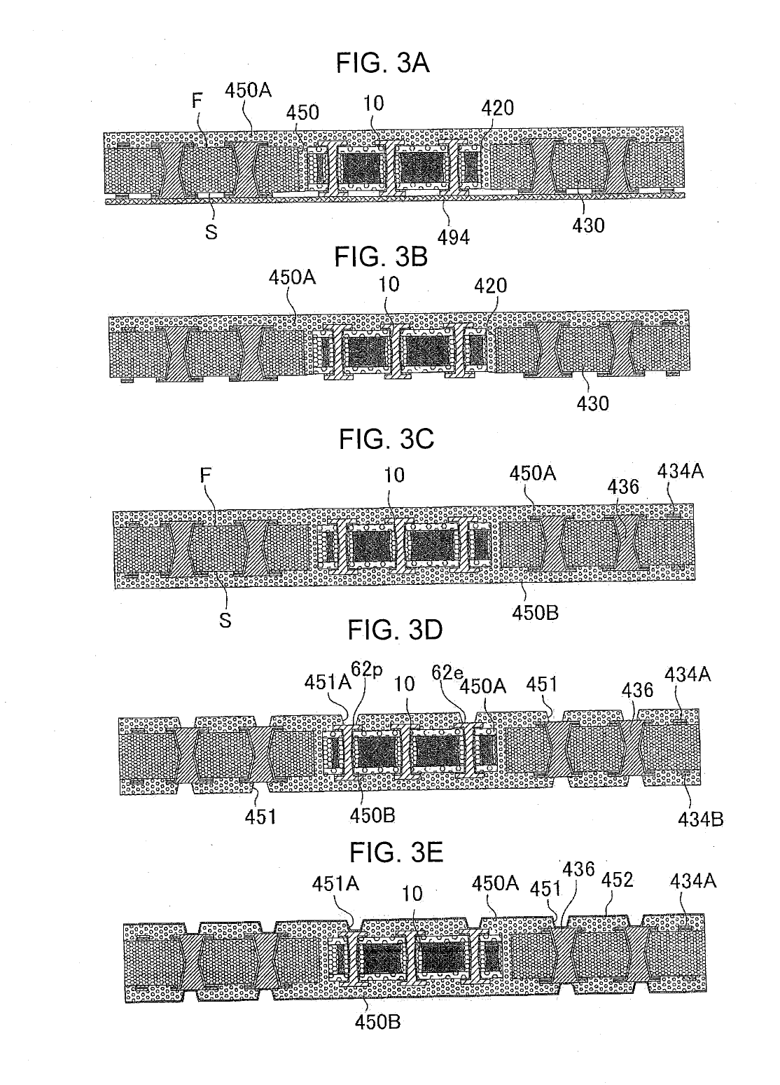

(6) A B-stage prepreg is laminated onto the first surface (F) of the core substrate 430. A heated press is used to leak resin from the prepreg into the opening to thereby fill the opening 420 with a filler (resin filler, 450) (FIG. 3A). The filler fills the gaps between the inner walls of the opening and the inductor component. The inductor component is thereby secured to the core base material. Insulating resin interlayer film may be laminated onto the core substrate instead of the prepreg. While the prepreg may be reinforced material such as fiberglass cloth, the insulating resin interlayer film is not a reinforced material. Both materials may contain inorganic particles such as glass. Finally, the filler may contain an inorganic material such as silica, and the like.

(7) After removing the tape (FIG. 3B), a B-stage prepreg is laminated onto the second surface (S) of the core substrate 430. The prepreg on the first surface and the second surface of the core base material is then cured. The insulating layers (resin interlayers (450A, 450B)) are then formed on the first surface and the second surface of the core base material (FIG. 3C).

(8) Conductive via connection openings (451A) are created in the insulating layer (450A) from the first surface to the electrodes (62p, 62e) on the inductor component 10 using a CO₂ gas laser. Conductive via openings 451 are formed simultaneously from the first surface to the conductive layer (434A) and the conductive through holes 436. Conductive via openings 451 are created in the insulating layer (450B) from the second surface to the conductive layer (434B) and the conductive through holes 436 (FIG. 3D). A coarse surface (not shown) is formed on the insulating layers (450A, 450B).

(9) An electroless plating film 452 is formed on the inner walls of the conductive via openings and on the insulating layer via electroless plating (FIG. 3E).

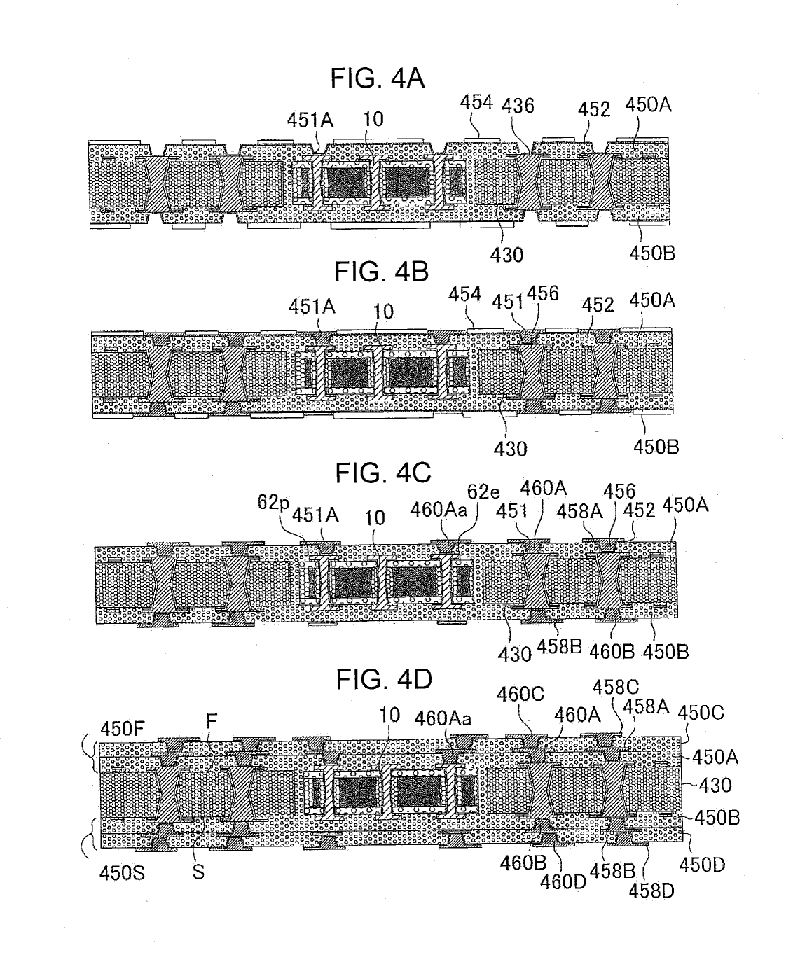

(10) A plating resist 454 is formed on the electroless plating film 452 (FIG. 4A).

(11) A copper film 456 is then electroplated onto the electroless plating film exposed through the plating resist 454 (FIG. 4B).

(12) Next, the plating resist 454 is removed using an amine solvent. Subsequently, the electroless plating film 452 exposed from the electroplated copper film 456 is removed via etching to create the conductive layers (458A, 458B) composed of the electroless plating film 452 and the electroplated copper film 456. The conductive layers (458A, 458B) include multiple lands for conductor circuits and conductive vias. Conductive vias (460A, 460B) and conductive connection vias (460Aa) are created at the same time (FIG. 4C). The conductive vias (460A, 460B) connect the conductive layer in the core base material or the conductive through holes with the conductive layers (458A, 458B) on the insulating layer. The conductive connection vias (460Aa) connect the electrodes (input electrode (62p), output electrode (62e)) on the inductor component with the conductive layer (458A) on the insulating layer.

(13) The processes illustrated in FIG. 3C through 4C are repeated to form the uppermost and lowermost insulating layers (450C, 450D) respectively on the insulating layers (450A, 450B). The conductive layers (458C, 458D) are formed on the uppermost and lowermost insulating layers (450C, 450D). Conductive vias (460C, 460D) are formed on the uppermost and lowermost insulating layers (450C, 450D), respectively connecting the conductive layers (458A, 458B) with the conductive layers (458C, 458D) (FIG. 4D). The first buildup layer (450F) and the second buildup layer (450S) are formed on the first surface (F) and the second surface (S) of the core base material. The buildup layers include the insulating layers, the conductive layers and conductive vias for connecting different conductive layers. In the first embodiment the first buildup layer further includes the conductive connection vias (460Aa).

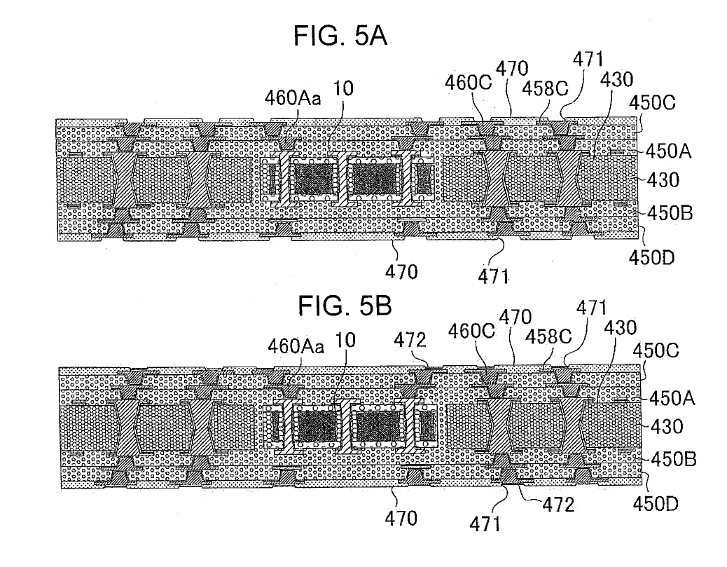

(14) Solder resist layers 470 are formed on the first and second buildup layers, and include openings 471 (FIG. 5A). The openings 471 expose the upper surfaces of the conductive layer and the conductive vias. The exposed portions function as pads.

(15) A nickel layer is formed on the pads, and a metal film 472 formed as a metal layer on the nickel layer. Besides the nickel-metal metal film, the film may be composed of nickel-palladium-metal. In the printed wiring board illustrated in FIG. 1, there are no conductive patterns formed in the region beneath the inductor component 10. With no conductive patterns directly beneath the inductor component, there is a large difference between the proportion of conductive material in the first buildup layer and the proportion of the conductive material in the second buildup layer, increasing the likelihood that the printed wiring board warps. Therefore, a predetermined conductive pattern may be formed in the region beneath the inductor component 10 to reduce the difference in the proportions of the conductive material in the buildup layers. As another example, a reinforcing material may be excluded from the insulating layer in the first buildup layer, while including a reinforcing material in the second buildup layer. Hereby, the printed wiring board is less likely to warp.

(16) Solder bumps (476F, 476S) are then formed on the pads of the first buildup layer and on the pads of the second buildup layer respectively. With the addition of the solder bumps, the printed wiring board 410 is complete (FIG. 1).

Semiconductor elements such as IC chips (not shown) may be mounted to the printed wiring board 410 via the solder bumps (476F). Thereafter, the printed wiring board may be mounted onto an external substrate such as a motherboard via the solder bumps (476S).

### Embodiment 2

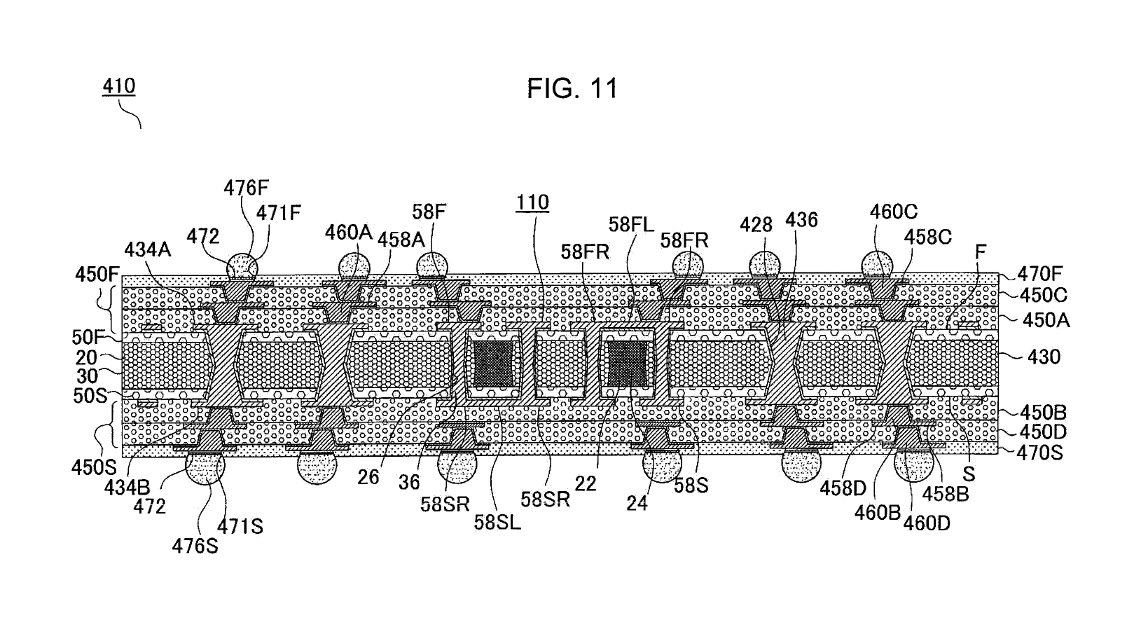

FIG. 11 is a cross-sectional view of a printed wiring board 410 according to a second embodiment. The printed wiring board 410 includes a core substrate 430. The core substrate 430 is formed from a laminate 30 including a first surface (F), and a second surface (S) opposite the first surface (F), with a first conductive layer (434A) and a second conductive layer (434B) on the first surface (F) and the second surface (S) of the laminate respectively, and a conductive through hole 436 connecting the first conductive layer (434A), and the second conductive layer (434B). The laminate 30 has a three-layer structure created by laminating resin insulating layers (50F, 50S) onto the surfaces of a core base material 20. The structure of the upper buildup layer (450F) and the lower buildup layer (450S) in the printed wiring board according to the second embodiment is same as the structure in the first embodiment.

An inductor portion 110 is formed in the core substrate 430. The inductor portion 110 is provided with a conductive through hole 36 created by plating and filling a through hole 26 passing through the core substrate 430. The inductor portion 110 is additionally provided with a connection pattern (58FL) connecting a through hole land (58FR) and a through hole land (58FR) on the first surface of the core substrate; and a connection pattern (58SL) connecting a through hole land (58SR) and a through hole land (58SR) on the second surface of the core substrate. Similarly to the first embodiment described with reference to FIG. 7A through 7D, the connection patterns (58FL), and the connection patterns (58SL) are positioned in a spiral through the conductive through hole 36 (i.e., formed in a spiral shape along an axial line in a direction parallel to the front and rear surfaces of the core substrate), such that the connection patterns (58FL), the connection patterns (58SL), and the conductive through hole 36 form the inductor.

An opening 22 is formed in the core base material 20 of the core substrate, and a magnetic body 24 housed inside the opening 22. Similarly to the first embodiment described with reference to FIG. 7C, the opening 22 stores a magnetic body 24 and the sidewalls thereof include projections and recesses. A recess is provided corresponding to the location of an individual conductive through hole 36. A projection is provided corresponding to the location between a conductive through hole and the next conductive through hole in a row. The recesses and projections reduce the distance between the magnetic body 24 and the conductive through holes 36, thereby increasing the inductance value.

Manufacturing a Core Substrate Provided with an Inductor Portion According to the Second Embodiment

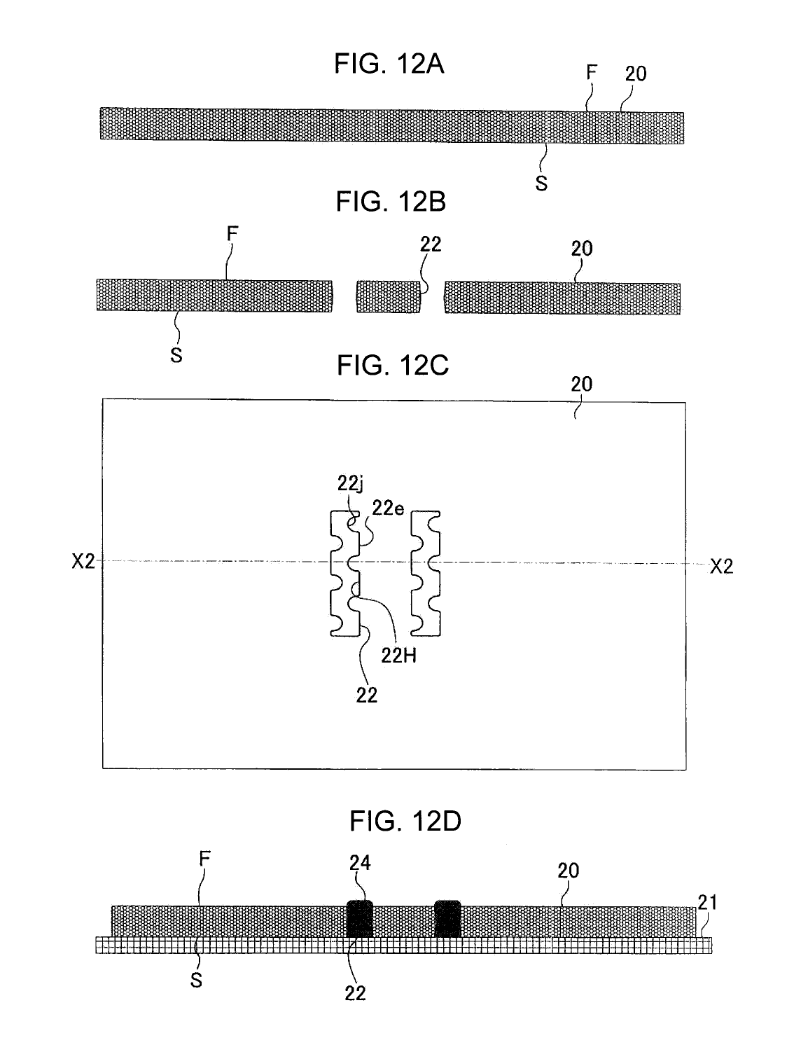

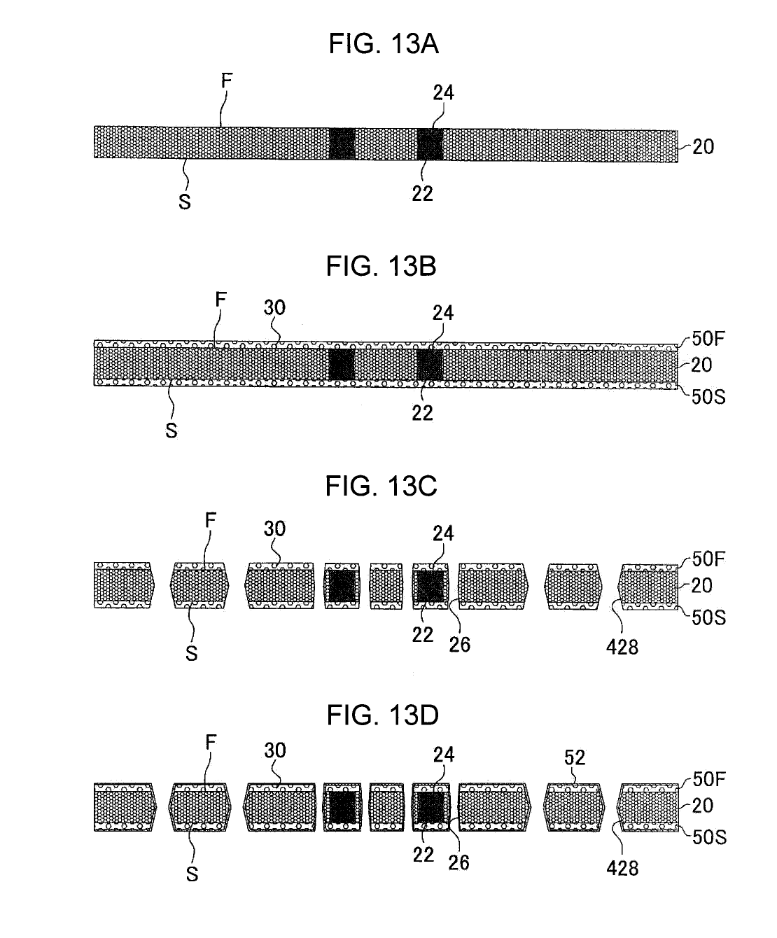

FIG. 12A through 14C are process diagrams illustrating a method of manufacturing the core substrate according to the second embodiment. A core base material 20 of thickness 0.15 mm is prepared (FIG. 12A). A core substrate is created by laminating a prepreg formed by soaking a core of fiberglass cloth in resin. The opening 22 is formed in the core base material 20 through laser machining (FIG. 12B). FIG. 12C is a plan view of the core base material. FIG. 12B corresponds to the cross-section X2-X2 in FIG. 12C. Similarly to the first embodiment, the recesses (22j) and projections (22e) are formed in the sidewalls (22H) of the opening 22. The core base material 20 is mounted on a jig 21, and the magnetic body 24 is vacuum printed inside the opening 22 using a metal mask (FIG. 12D). The magnetic body is a composite of a magnetic metal and an organic material such as resin and the like. The surfaces of the core base material 20 are then polished (FIG. 13A).

A prepreg is laminated onto the first surface (F) and the second surface (S) of the core base material 20 to form the first resin insulating layer (50F) and the second resin insulating layer (50S) and produce the laminate 30 (FIG. 13B). The laser used for forming the opening 22 is used to create the through hole 26 for the inductor portion at through hole formation sites on the laminate 30, and to cut connection through holes 428 through the first surface and the second surface of the core substrate (FIG. 13C).

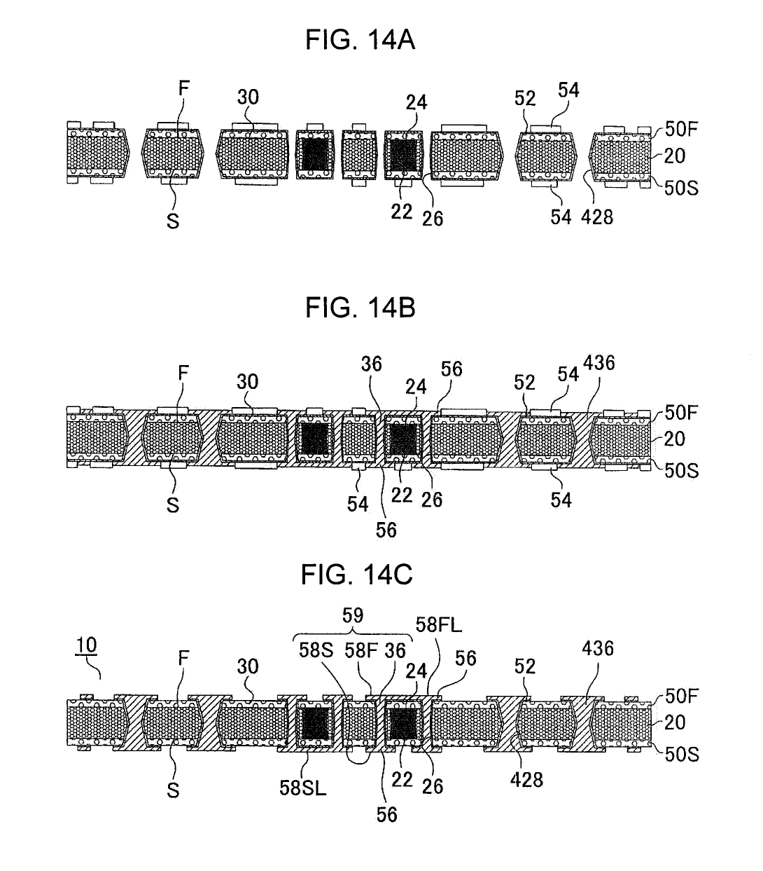

An electroless plating film 52 is formed on the first resin insulating layer (50F), the second resin insulating layer (50S), and the inner walls of the through holes (26, 428) (FIG. 13D). A plating resist 54 is formed on the electroless plating film 52 (FIG. 14A). A copper film 56 is electroplated onto the electroless plating film 52 on the portions not including the plating resist 54. The insides of the through holes 26, 428 are filled with electroplated film to form conductive through holes (36, 436) (FIG. 14B). The plating resist is peeled off to expose the electroless plating film on the portions not including the electroplated film 56 to form the first conductive pattern (58F) and the second conductive pattern (58S) which respectively include the connection patterns (58FL) and the connection patterns (58SL) (FIG. 14C). The core substrate is thereby complete. The inductor portion according to the second embodiment may be produced while manufacturing the printed wiring board, thereby simplifying the production thereof.

When a spiral-shaped inductor were to be laminated onto a substrate, it may be difficult to connect inductors disposed in different layers when the inductor component is formed from a metal sheet.

A printed wiring board according to an embodiment of the present invention has a built-in high-value inductor.

A printed wiring board according to an embodiment of the invention is provided with core substrate including a cavity for housing an inductor component, a first surface and a second surface opposite the first surface; a first buildup layer formed on the first surface of the core substrate; and a second buildup layer formed on the second surface of the core substrate. The inductor component includes first openings and second opening provided between the first openings; a resin insulating layer including a first surface on the same side as the first surface of the core substrate, and a second surface on the same side as the first surface of the core substrate; conductive through holes made by filling the first openings with conductive material; a magnetic body made by filling the second opening with magnetic material; and interconnects disposed on the first surface and the second surface and connecting the conductive through holes. The conductive through holes and interconnects are positioned to form a spiral shape.

The inductor is formed in a spiral along a direction parallel to the plane of the resin insulating layer constituting the inductor component, and loops horizontally and not in the thickness direction of the inductor component. Therefore, a printed wiring board according to an embodiment of the present invention may accommodate an inductor component with an increased number of turns without increasing the thickness thereof, to thereby obtain a desired inductance property (inductance value, or Q value).

In a preferred embodiment, the sidewalls of the second opening which houses the magnetic body includes projections and recesses. The recesses are provided corresponding to the location of the conductive through holes. The projections are provided corresponding to the location between the conductive through holes. The projections and recesses reduce the distance between the magnetic body and the conductive through holes, thereby increasing the inductance value.

Obviously, numerous modifications and variations of the present invention are possible in light of the above teachings. It is therefore to be understood that within the scope of the appended claims, the invention may be practiced otherwise than as specifically described herein.

What is claimed is:

1. A printed wiring board, comprising:
a core substrate having a cavity;
an inductor component positioned in the cavity of the core substrate;
a first buildup layer formed on a first surface of the core substrate; and
a second buildup layer formed on a second surface of the core substrate on an opposite side of the substrate with respect to the first surface,
wherein the inductor component comprises a resin insulating layer having a plurality of first openings and a second opening formed between the first openings, a plurality of conductive through holes comprising conductive material and formed in the plurality of first openings, respectively, a magnetic body comprising magnetic material and formed in the second opening, a first interconnect formed on a first surface of the resin insulating layer and connecting the conductive through holes on the first surface of the resin insulating layer, and a second interconnect formed on a second surface of the resin insulating layer and connecting the conductive through holes on the second surface of the resin insulating layer, and the first interconnect, the second interconnect and the plurality of conductive through holes are positioned to form a spiral structure.

2. The printed wiring board according to claim 1, wherein the first buildup layer and the second buildup layer have a same number of conductive layers.

3. The printed wiring board according to claim 1, wherein the second opening has a plurality of recess portions and a plurality of projection portions such that the plurality of conductive through holes is formed in the plurality of recess portions of the second opening, respectively, and each of the projection portions is formed between adjacent conductive through holes.

4. The printed wiring board according to claim 1, wherein each of the conductive through holes has a cylindrical shape tapering from the first surface of the resin insulating layer toward the second surface of the resin insulating layer and from the second surface of the resin insulating layer toward the first surface of the resin insulating layer, and the second opening has a V shape cross-section narrowing from the first surface of the resin insulating layer toward the second surface of the resin insulating layer in a width and a V shape cross-section narrowing from the second surface of the resin insulating layer toward the first surface of the resin insulating layer in the width.

5. The printed wiring board according to claim 4, wherein each of the conductive through holes has the cylindrical shape having a smallest diameter at a distance from the first surface of the resin insulation layer equal to a distance from the first surface of the resin insulation layer at which the second opening has a narrowest width.

6. The printed wiring board according to claim 1, wherein the resin insulating layer comprises a laminated structure comprising three resin insulating layers such that the second opening is formed in a middle resin insulating layer and two outer resin insulating layers is covering the second opening formed in the middle resin insulating layer.

7. The printed wiring board according to claim 1, wherein the plurality of first openings is arrayed in two rows, and the second opening is formed between the two rows and has a plurality of recess portions and a plurality of projection portions such that the plurality of conductive through holes is formed in the plurality of recess portions of the second opening, respectively, and each of the projection portions is formed between adjacent conductive through holes.

8. The printed wiring board according to claim 1, further comprising:
a resin material filling a space formed between the core substrate and the inductor component positioned in the cavity of the core substrate.

9. The printed wiring board according to claim 1, wherein the first buildup layer comprises an outermost conductive layer comprising a plurality of pads such that the plurality of pads is positioned to mount a semiconductor component on the first buildup layer, and the second buildup layer comprises an outermost conductive layer comprising a plurality of pads such that the plurality of pads is positioned to mount an external substrate on the second buildup layer.

10. The printed wiring board according to claim 2, wherein the second opening has a plurality of recess portions and a plurality of projection portions such that the plurality of conductive through holes is formed in the plurality of recess portions of the second opening, respectively, and each of the projection portions is formed between adjacent conductive through holes.

11. A printed wiring board, comprising:
a core substrate;
a first buildup layer formed on a first surface of the core substrate; and
a second buildup layer formed on a second surface of the core substrate on an opposite side of the substrate with respect to the first surface,
wherein the core substrate has an inductor portion comprising a plurality of conductive through holes which comprises conductive material and which is formed in a plurality of first openings in the core substrate, respectively, a magnetic body comprising magnetic material and formed in a second opening formed between the first openings, a first interconnect formed on a first surface of the core substrate and connecting the conductive through holes on the first surface of the core substrate, and a second interconnect formed on a second surface of the core substrate and connecting the conductive through holes on the second surface of the core substrate, and the first interconnect, the second interconnect and the plurality of conductive through holes are positioned to form a spiral structure.

12. The printed wiring board according to claim 11, wherein the first buildup layer and the second buildup layer have a same number of conductive layers.

13. The printed wiring board according to claim 11, wherein the second opening has a plurality of recess portions and a plurality of projection portions such that the plurality of conductive through holes is formed in the plurality of recess portions of the second opening, respectively, and each of the projection portions is formed between adjacent conductive through holes.

14. The printed wiring board according to claim 11, wherein each of the conductive through holes has a cylindrical shape tapering from the first surface of the core substrate toward the second surface of the core substrate and from the second surface of the core substrate toward the first surface of the core substrate, and the second opening has a V shape cross-section narrowing from the first surface of the core substrate toward the second surface of the core substrate in a width and a V shape cross-section narrowing from the second surface of the core substrate toward the first surface of the core substrate in the width.

15. The printed wiring board according to claim 14, wherein each of the conductive through holes has the cylindrical shape having a smallest diameter at a distance from the first surface of the core substrate equal to a distance from the first surface of the core substrate at which the second opening has a narrowest width.

16. The printed wiring board according to claim 11, wherein the core substrate comprises a laminated structure comprising three resin insulating layers such that the second opening is formed in a middle resin insulating layer and two outer resin insulating layers is covering the second opening formed in the middle resin insulating layer.

17. The printed wiring board according to claim 11, wherein the plurality of first openings is arrayed in two rows, and the second opening is formed between the two rows and has a plurality of recess portions and a plurality of projection portions such that the plurality of conductive through holes is formed in the plurality of recess portions of the second opening, respectively, and each of the projection portions is formed between adjacent conductive through holes.

18. The printed wiring board according to claim 11, wherein the first buildup layer comprises an outermost conductive layer comprising a plurality of pads such that the plurality of pads is positioned to mount a semiconductor component on the first buildup layer, and the second buildup layer comprises an outermost conductive layer comprising a plurality of pads such that the plurality of pads is positioned to mount an external substrate on the second buildup layer.

19. The printed wiring board according to claim 12, wherein the second opening has a plurality of recess portions and a plurality of projection portions such that the plurality of conductive through holes is formed in the plurality of recess portions of the second opening, respectively, and each of the projection portions is formed between adjacent conductive through holes.

20. The printed wiring board according to claim 12, wherein the plurality of first openings is arrayed in two rows, and the second opening is formed between the two rows and has a plurality of recess portions and a plurality of projection portions such that the plurality of conductive through holes is formed in the plurality of recess portions of the second opening, respectively, and each of the projection portions is formed between adjacent conductive through holes.
